(19) United States
(12) Patent Application Publication
(10) Pub. No.: US 2005/0108356 A1
(43) Pub. Date: May 19, 2005

(54) Method and apparatus for bandwidth efficient distribution of content

(76) Inventors: Marcel-Catalin Rosu, Ossining, NY (US); Debanjan Saha, Mohegan Lake, NY (US); Sambit Sahu, Mahopac, NY (US); Anees A. Shaikh, Yorktown Heights, NY (US)

Correspondence Address: Moser, Patterson & Sheridan, Suite 100, 595 Shrewsbury Avenue, Shrewsbury, NJ, 07702, US

(21) Appl. No.: 10/699,368

(22) Filed: Oct. 31, 2003

(51) Int. Cl. G06F 15/167; G06F 15/16

(52) U.S. Cl. 709/214; 709/245

(57) ABSTRACT

In one embodiment, the present invention is a method and an apparatus for bandwidth efficient distribution of content over a computer network. In one embodiment, a server cooperates with clients to reduce the usage of server bandwidth, thereby reducing bandwidth-associated distribution costs. The server controls the way that content is distributed within the system, and the clients/receivers may act as intermediate forwarders of data packets. In one embodiment, this is accomplished by sending data items to a first group of receivers on a packet-by-packet basis using unicast communication. The first group of receivers then sends the packets on to a second set of receivers, and the process continues until the packet is forwarded to all intended receivers.

### BACKGROUND

The present invention relates generally to computer systems and computer networks, and relates more particularly to content distribution over computer networks. Specifically, the present invention relates to a method and apparatus for bandwidth efficient delivery of content over a computer network.

A number of internet applications work in a client-server mode wherein servers located in data centers distribute the same content or data (i.e., “packets”) to a number of clients. Examples of such applications include audio/video streaming, software distribution and multiparty online gaming, among others. In most of these applications, although the servers send the same data to each client in a set of clients, the data is sent to one client at a time using a unicast distribution system.

FIG. 1 is a schematic diagram illustrating one embodiment of a unicast distribution system. Such a method is also referred to as point-to-point communication. As illustrated, the server sends a plurality of copies of the same data to a plurality of clients using a unicast forwarding mechanism. The packets are typically distributed on a one-to-one basis; that is, an individual copy of the same information is produced and sent to each client (e.g., a sender with ten receivers would send ten packets along ten routes). Consequently, a major cost associated with the distribution of content from server to client(s) is that of bandwidth. When the number of clients is particularly large, e.g., in the case of multiparty online games, bandwidth costs may dominate the total cost of hosting the application.

One conventional way to reduce the usage and cost of bandwidth is to use a point-to-multipoint multicast distribution system. In a point-to-multipoint multicast distribution system, the receivers form a distribution tree wherein the sender is the “root” of the tree and the receivers are the “leaves”. Routers form intermediate nodes in the tree and are adapted to forward data items downstream, i.e., towards the receivers. Thus, the sender sends a single copy of the data item, addressed to a group of receivers, and as the data is routed through the multicast distribution tree it is copied by the intermediate routers and sent over diverging branches of the distribution tree. Although such systems can potentially reduce the usage and cost of bandwidth, they are hampered by a lack of scalability and interoperability. Furthermore, such multicast systems typically require an overlay infrastructure, and the cost of deployment and maintenance for multicast overlays can be quite costly. Other solutions, such as peer-to-peer systems, must run slow and complex protocols to create multicast overlays and can not be easily reconfigured on a packet-by-packet basis. This creates difficulties when the multicast group membership changes or when system hardware (e.g., intermediate receivers or routers) fail.

Thus, there is a need for a method and apparatus for a simplified, flexible, and bandwidth efficient system for point-to-multipoint distribution of content over a computer network.

### SUMMARY OF THE INVENTION

In one embodiment, the present invention is a method and an apparatus for bandwidth efficient distribution of content over a computer network. In one embodiment, a server cooperates with clients to reduce the usage of server bandwidth, thereby reducing bandwidth-associated distribution costs. The server controls the way that content is distributed within the system, and the clients/receivers may act as intermediate forwarders of data packets. In one embodiment, this is accomplished by sending data items to a first group of receivers on a packet-by-packet basis using unicast communication. The first group of receivers then sends the packets on to a second set of receivers, and the process continues until the packet is forwarded to all intended receivers. Namely, each data packet contains a point-to-multipoint distribution sub-tree. Under this novel distribution scheme, different packets reach different receivers via different intermediate receivers, thereby reducing the usage and cost of bandwidth.

### BRIEF DESCRIPTION OF THE DRAWINGS

So that the manner in which the above recited embodiments of the invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic illustration of a conventional unicast distribution system;

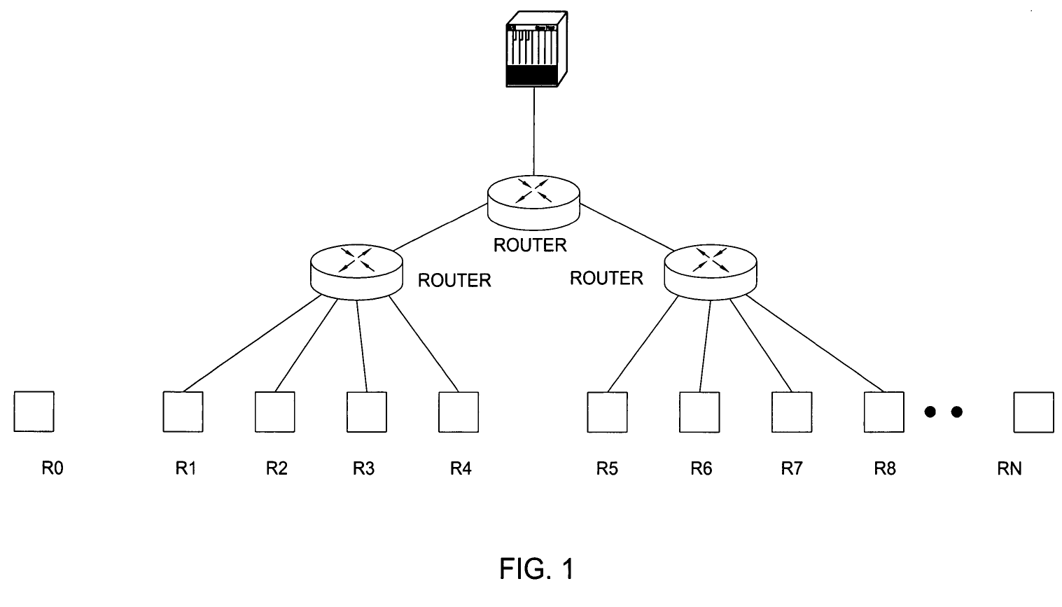

FIG. 2 is a schematic illustration of one embodiment of a point-to-multipoint distribution system according to the present invention;

FIG. 3 is a flow diagram illustrating one method of distributing content using the system illustrated in FIG. 2; and

FIG. 4 is a block diagram of a system for executing the method in accordance with embodiments of the present invention.

To facilitate understanding, identical reference numerals have been used, where possible, to designate identical elements that are common to the figures.

### DETAILED DESCRIPTION

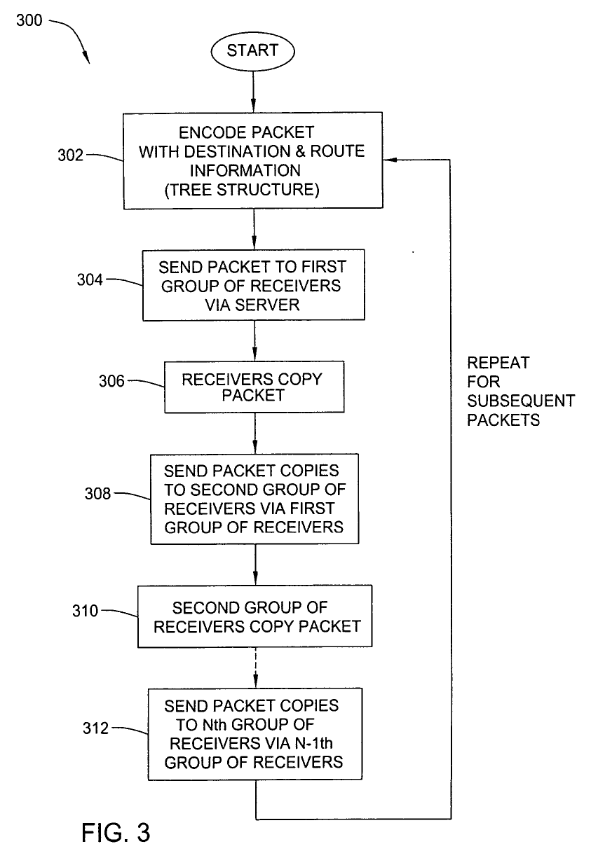

The present invention is a method and an apparatus for bandwidth efficient distribution of content over a computer network. FIG. 3 is a flow diagram illustrating one embodiment of a method 300 of distributing content. In step 302, a sender (e.g., a server) encodes a first data packet (containing data to be distributed) with a multicast tree structure that specifies a list of receivers (or levels/groups of receivers) to which the first packet should be sent and a path along which the first packet should be sent. In step 304, the first packet is sent to a first group of receivers, for example, using a conventional unicast distribution system as described herein. In step 306, each receiver in the first group of receivers, having received the first packet, makes a specified number of copies of the first packet, and in step 308 each receiver in the first group sends its packet copies to a second group of receivers as specified by the tree structure with which the first packet is encoded. In step 310, each receiver in the second group of receivers copies the first packet, and these copies made by the second group of receivers are forwarded to a subsequent group of receivers, for example using a unicast distribution system. Thus, steps 306 and 308 are essentially repeated N-1 times, wherein N is the number of groups of receivers to which the first packet must be forwarded. The multicast distribution tree structure will specify the paths (i.e., the intermediate receivers) by which the first packet arrives at each receiver in the tree. Once the first packet has reached all receivers as defined by the multicast distribution tree or a portion thereof, the method 300 is repeated for subsequent data packets.

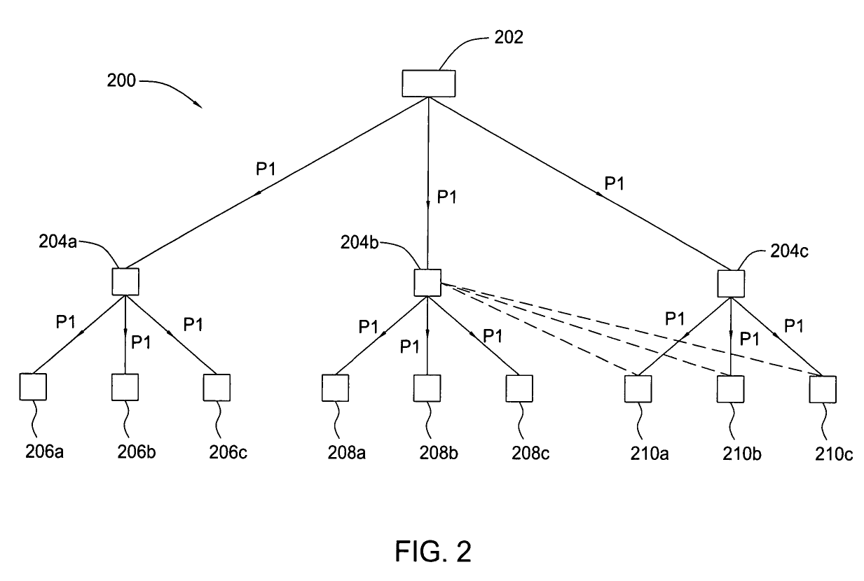

FIG. 2 is a schematic illustration of one embodiment of a point-to-multipoint distribution tree structure 200 for carrying out the method 300 illustrated in FIG. 3. In the embodiment illustrated, the system 200 is a two-level system that comprises a server 202, a first group of receivers 204a-204c (hereinafter referred to as “receivers 204” and showing a “fan out” of three receivers), a second group of receivers 206a-206c (hereinafter referred to as “receivers 206” and showing a “fan out” of three receivers), a third group of receivers 208a-208c (hereinafter referred to as “receivers 208” and showing a “fan out” of three receivers), and a fourth group of receivers 210a-210c (hereinafter referred to as “receivers 210” and showing a “fan out” of three receivers). Although four sets of receivers 204, 206, 208 and 210 are illustrated, those skilled in the art will appreciate that an infinite number of receivers and groups of receivers can be used to advantage with the present invention, and the grouping of receivers will depend on parameters determined by the server as described further herein.

In one embodiment, the sender (e.g., server) 202 sends a packet p₁ intended for the receivers 204, 206, 208 and 210 (step 304). The packet p₁ is sent by the server 202 to the first group of receivers 204 using a unicast communication system as described herein. The packet p₁ contains data and the multicast distribution tree, or at least the relevant portion of the multicast distribution tree that defines a list of receivers to which the first group of receivers 204 should forward the packet p₁ (step 302). Each receiver 204 in the first group of receivers 204 makes the requisite number of copies of the packet p₁ (step 306) and sends a copy of the packet p₁ to each subsequent receiver 206, 208 or 210 in its distribution sequence or structure (step 308). Thus, receiver 204a forwards the packet p₁ to the second group of receivers 206, receiver 204b forwards the packet p₁ to the third group of receivers 208, and the receiver 204c forwards the packet p₁ to the fourth group of receivers 210. Forwarding from the receivers 204 to the second, third or fourth groups of receivers 206, 208 or 210 is accomplished using a unicast communication system.

In one embodiment, the server 202 determines and controls the distribution process for the packet p₁, e.g., the server 202 can alter the multicast distribution tree structure for each packet sent. The server 202 encodes the packet p₁ with the list of receivers 204, 206, 208 or 210 to which the packet p₁ is to be delivered, as well as with the order in which the packet p₁ is to be delivered to the individual receivers 204, 206, 208 or 210 (i.e., which receivers forward the packet p₁ to which other receivers). Thus, the packet p₁ essentially contains a point-to-multipoint distribution sub-tree.

Although the embodiment illustrated in FIG. 2 depicts a distribution system 200 having two levels of receivers (i.e., receivers 204 and receivers 206/208/210) forwarding one packet p₁ of data, those skilled in the art will appreciate that the distribution system 200 may comprise an infinite number of receivers (e.g., receiver group N in step 312 of FIG. 3) for forwarding an infinite number of packets. The actual number of receivers (“fan out”) and levels into which the receivers are grouped (“depth”) will depend on application requirements or metrics including latency, reliability, incentive to conserve bandwidth, and available bandwidth at each receiver, among others. For example, for applications requiring low latency, small depth and fan out may be desired. If an application values low bandwidth costs over latency, deep trees with large fan out may be better suited to handle these requirements.

Thus, the number of permutations for packet delivery routes is a function of the number of receivers in the distribution tree. That is, using the distribution method illustrated in FIGS. 2 and 3, different packets may be sent to different receivers via different intermediate receivers. The server 202 has substantially complete control over the distribution process, and in one embodiment, the server 202 can change the distribution tree on a packet-by-packet basis. Consequently, even if receivers are spontaneously added to or dropped from the distribution tree, the variable structure of the tree can substantially reduce failures in packet delivery by simply re-routing packets to available receivers. For example, if receiver 204c is dropped from the system 200 illustrated in FIG. 2, the receiver 204b can deliver the packet p₁ to the fourth group of receivers 210, as illustrated by the dotted lines connecting receiver 204b to the receivers 210. In one embodiment, packets are further encoded with forward error correction coding to further reduce packet loss. Therefore, each receiver need only receive one subset of packets in order to reconstruct the content. Furthermore, the sender 202 can adjust the structure of the multicast distribution tree to address different metrics, including, but not limited to, cost, delay and bandwidth constraints.

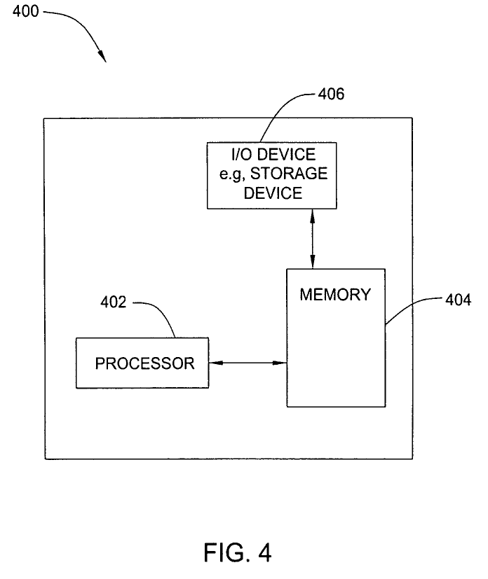

FIG. 4 is a high level block diagram of the present invention implemented using a general purpose computing device 400. In one embodiment, a general purpose computing device 400 comprises a processor 402, a memory 404 and various input/output (I/O) devices 406 such as a display, a keyboard, a mouse, a modem, and the like. In one embodiment, at least one I/O device is a storage device (e.g., a disk drive, an optical disk drive, a floppy disk drive). In one embodiment, the method for content distribution described herein with reference to the preceding Figures can be implemented as a software application that is retrieved from the storage device 406 and is loaded onto the memory 404. The processor 402 can then execute the method in the memory in accordance with embodiments of the present invention. As such, it is contemplated that some and/or all of the steps of the methods and the data structure discussed above can be stored on a computer readable medium.

Thus, the present invention represents a significant advancement in the field of content distribution over computer networks. A point-to-multipoint system is provided that consumes significantly less bandwidth at a given time than conventional point-to-point systems. The server controls the destinations and routes for each packet that the server sends, and destinations and routes may be altered on a packet-by-packet basis to reduce packet loss. The system is simple and does not require deployment or maintenance of multicast overlays, which can be costly. The speed and simplicity of the system make the system robust against changes in multicast group membership or failure of individual receivers.

While foregoing is directed to the preferred embodiment of the present invention, other and further embodiments of the invention may be devised without departing from the basic scope thereof, and the scope thereof is determined by the claims that follow.

1. A method for distributing content to a plurality of receivers, wherein said content is packetized into one or more packets, comprising:
establishing a multicast distribution tree rooted at a sender; and
directing the transmission of one or more packets along at least a portion of the multicast distribution tree,
wherein the at least a portion of the multicast distribution tree along which the one or more packets travel is varied on a packet-by-packet basis.

2. The method of claim 1, wherein the step of directing the transmission further comprises:
encoding each of the one or more packets with at least a portion of said multicast distribution tree, wherein the multicast distribution tree identifies the receiver to which each packet is to be delivered and the path along which each packet is to travel to the receiver.

3. The method of claim 2, wherein the multicast distribution tree is sender-defined.

4. The method of claim 1, wherein the step of directing the transmission comprises:
sending one of said one or more packets to a first group of receivers;
creating at least one copy of the packet by at least one of said first group of receivers; and
forwarding at least one copy of the packet to at least one receiver in a subsequent level within said multicast distribution tree.

5. The method of claim 1, wherein each receiver that is not a final destination for said one or more packets copies and forwards said one or more received packets to a subsequent receiver in accordance with said at least a portion of the multicast distribution tree.

6. The method of claim 2, further comprising:
encoding at least some of the one or more packets with forward error correction coding.

7. The method of claim 4, wherein transmissions from sender-to-receiver and receiver-to-receiver are individually accomplished using unicast distribution communication.

8. The method of claim 1, wherein the step of establishing a multicast distribution tree comprises:
adjusting a structure of the multicast distribution tree to address a given metric, wherein said metric is at least one of cost, delay, bandwidth, latency or reliability.

9. A method for distributing content to a plurality of receivers, wherein said content is packetized into at least one packet, comprising:
establishing a multicast distribution tree rooted at a sender; and
directing the transmission of the at least one packet along at least a portion of the multicast distribution tree,
wherein the receivers to which the at least one packet is sent, and the paths along which the at least one packet is sent to the receivers, are defined by the sender.

10. The method of claim 9, wherein the at least a portion of the multicast distribution tree along which the one or more packets travel is varied on a packet-by-packet basis.

11. The method of claim 9, wherein the step of directing the transmission further comprises:
encoding the at least one packet with at least a portion of said multicast distribution tree, wherein the multicast distribution tree identifies the receivers to which the at least one packet is to be delivered and the paths along which the at least one packet is to travel to the receivers.

12. The method of claim 9, wherein the step of directing the transmission comprises:
sending the at least one packet to a first group of receivers;
creating at least one copy of the at least one packet by at least one of said first group of receivers; and
forwarding the at least one copy of the at least one packet to at least one receiver in a subsequent level within said multicast distribution tree.

13. The method of claim 9, wherein each receiver that is not a final destination for the at least one data packet copies and forwards the at least one received packet to a subsequent receiver in accordance with said at least a portion of the multicast distribution tree.

14. The method of claim 11, further comprising:
encoding the at least one packet with forward error correction coding.

15. The method of claim 12 wherein transmissions from sender-to-receiver and receiver-to-receiver are individually accomplished using unicast distribution communication.

16. The method of claim 9, wherein the step of establishing a multicast distribution tree comprises:
adjusting a structure of the multicast distribution tree to address a given metric, wherein said metric is at least one of cost, delay, bandwidth, latency or reliability.

17. A system for distributing content to a computer network comprising:
a server adapted for sending at least one data packet, where said at least one data packet contains at least a portion of a multicast distribution tree.
wherein both the server and the first group of receivers each comprise a packet forwarding mechanism.

18. The system of claim 17, wherein the server is adapted to define a distribution tree for distributing the at least one data packet to the at least a first group of receivers.

19. The system of claim 17, wherein the distribution tree defines receivers to which the at least one data packet is directed and the paths along which the at least one data packet travels to the receivers.

20. The system of claim 17, wherein the system is adapted to distribute content on a packet-by-packet basis.

21. The system of claim 17, wherein each receiver that is not a final destination for the at least one data packet is adapted to copy the at least one data packet and forward the at least one data packet on to a subsequent receiver.

22. The system of claim 17, wherein the server is adapted to encode the at least one data packet with forward error correction coding.

23. A computer readable medium containing an executable program for distributing content to a plurality of receivers, wherein said content is packetized into one or more packets, where the program performs the steps of:
establishing a multicast distribution tree rooted at a sender; and
directing the transmission of one or more packets along at least a portion of the multicast distribution tree,
wherein the at least a portion of the multicast distribution tree along which the one or more packets travel is varied on a packet-by-packet basis.

24. The computer readable medium of claim 23, wherein the step of directing the transmission further comprises:
encoding each of the one or more packets with at least a portion of said multicast distribution tree, wherein the multicast distribution tree identifies the receiver to which each packet is to be delivered and the path along which each packet is to travel to the receiver.

25. The computer readable medium of claim 23, wherein the multicast distribution tree is sender-defined.

26. The computer readable medium of claim 23, wherein the step of directing the transmission comprises:
sending one of said one or more packets to a first group of receivers;
creating at least one copy of the packet by at least one of said first group of receivers; and
forwarding at least one copy of the packet to at least one receiver in a subsequent level within said multicast distribution tree.

27. The computer readable medium of claim 23, wherein each receiver that is not a final destination for said one or more packets copies and forwards said one or more received packets to a subsequent receiver in accordance with said at least a portion of the multicast distribution tree.

28. The computer readable medium of claim 24, further comprising:
encoding at least some of the one or more packets with forward error correction coding.

29. The computer readable medium of claim 26, wherein transmissions from sender-to-receiver and receiver-to-receiver are individually accomplished using unicast distribution communication.

30. The computer readable medium of claim 23, wherein the step of establishing a multicast distribution tree comprises:
adjusting a structure of the multicast distribution tree to address a given metric.

31. The computer readable medium of claim 23, wherein the step of establishing a multicast distribution tree comprises:
adjusting a structure of the multicast distribution tree to address a given metric, wherein said metric is at least one of cost, delay, bandwidth, latency or reliability.

32. A computer readable medium containing an executable program for distributing content to a plurality of receivers, wherein said content is packetized into one or more packets, where the program performs the steps of:
establishing a multicast distribution tree rooted at a sender; and
directing the transmission of the at least one packet along at least a portion of the multicast distribution tree,
wherein the receivers to which the at least one packet is sent, and the paths along which the at least one packet is sent to the receivers, are defined by the sender.

33. The computer readable medium of claim 32, wherein the step of directing the transmission further comprises:
encoding the at least one packet with at least a portion of said multicast distribution tree, wherein the multicast distribution tree identifies the receivers to which the at least one packet is to be delivered and the paths along which the at least one packet is to travel to the receivers.

34. The computer readable medium of claim 32, wherein the step of directing the transmission comprises:
sending the at least one packet to a first group of receivers;
creating at least one copy of the at least one packet by at least one of said first group of receivers; and
forwarding the at least one copy of the at least one packet to at least one receiver in a subsequent level within said multicast distribution tree.

35. The computer readable medium of claim 32, wherein each receiver that is not a final destination for the at least one data packet copies and forwards the at least one received packet to a subsequent receiver in accordance with said at least a portion of the multicast distribution tree.

36. The computer readable medium of claim 33, further comprising:
encoding the at least one packet with forward error correction coding.

37. The computer readable medium of claim 34 wherein transmissions from sender-to-receiver and receiver-to-receiver are individually accomplished using unicast distribution communication.

38. The computer readable medium of claim 32, wherein the step of establishing a multicast distribution tree comprises:
adjusting a structure of the multicast distribution tree to address a given metric, wherein said metric is at least one of cost, delay, bandwidth, latency or reliability.
